(19) United States
(12) Patent Application Publication
(10) Pub. No.: US 2002/0126957 A1
(43) Pub. Date: Sep. 12, 2002

(54) Grating type optical component, a manufacturing method thereof, a mask used in manufacturing the grating type optical component, and an optical module using the grating type optical component

(75) Inventors: Mariko Miyazawa, Chiyoda-ku (JP); Shigehito Yodo, Chiyoda-ku (JP); Yusei Shirasaka, Chiyoda-ku (JP); Toshihiko Ota, Chiyoda-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/151,851

(22) Filed: May 22, 2002

Related U.S. Application Data
(62) Division of application No. 09/718,394, filed on Nov. 24, 2000.

(30) Foreign Application Priority Data
Nov. 25, 1999 (JP) 11-334181
Oct. 18, 2000 (JP) 2000-318087

(51) Int. Cl. G02B 6/34; G02B 6/26; G02B 6/293

(52) U.S. Cl. 385/37; 385/15; 385/24

(57) ABSTRACT

A grating type optical component is provided, in which a plurality of light beams having wavelengths different from one another can be reflected, the loss is small, and the cost is low. The grating type optical component is composed of plural kinds of gratings (6a to 6d) that reflect different wavelengths of light and are formed at once in an optical fiber (2) and arranged serially in its longitudinal direction, so that there are no fusion splicing portions between the gratings. The plural kinds of serially-connected gratings (6a to 6d) are together housed in a temperature compensating package (3N) for compensating the temperature dependency of the gratings (6a to 6d). In forming the gratings (6a to 6d), prepare a phase mask (8N) in which a plurality of grating forming patterns (1a to 1d) different from one another are formed and arranged transversely. The phase mask (8N) covers the optical fiber (2) such that the grating forming patterns (1a to 1d) face the optical fiber (2). The optical fiber (2) is then irradiated with ultraviolet light through the phase mask (8N).

### BACKGROUND OF THE INVENTION

1. Field of the Invention

The present invention relates to a grating type optical component obtained by forming gratings in a grating forming region of an optical waveguide such as an optical fiber, and relates to a manufacturing method thereof, a mask used in manufacturing the grating type optical component, and an optical module using the grating type optical component.

2. Description of the Related Art

As the information-oriented society develops and expands, the amount of communication data continues to increase exponentially. It is therefore an indispensable task for optical fiber communication to increase its speed and capacity. One of recently discussed approaches to this task of increasing the speed and the capacity is a wavelength division multiplexing transmission method in which a plurality of signal light beams having different wavelengths are transmitted through a single optical fiber.

What is investigated specifically in the optical communication system of this wavelength division multiplexing light transmission method is, for example, to use as system monitoring light a reflected light beam obtained by selectively reflecting a light beam in a predetermined wavelength band out of light beams transmitted by wavelength division multiplexing transmission. In this investigation, a filter type optical component is used to selectively reflect a light beam in a predetermined wavelength band and to selectively pass light beams in other wavelength bands. This filter type optical component is a grating type optical component obtained by forming a grating to an optical waveguide such as an optical fiber.

The grating mentioned above is a diffraction grating formed by cyclically changing the refractive index of an optical waveguide such as an optical fiber along its longitudinal direction. A widely used method of forming the grating is the phase mask method, which utilizes a mask (phase mask). In this phase mask method, a grating forming region of an optical waveguide such as an optical fiber is irradiated with ultraviolet light through a mask on which a grating forming pattern is drawn (phase mask) to form the grating in the optical waveguide. In other words, grating formation by the phase mask method uses the ultraviolet light irradiation to place, in a cyclic arrangement, parts that have a high refractive index and parts that have a low refractive index because they are not irradiated with ultraviolet light in the longitudinal direction of the optical waveguide.

The core of an optical fiber is generally formed from silica (SiO₂) glass doped with germanium (Ge). Receiving intense ultraviolet irradiation, an optical waveguide such as an optical fiber whose core is made of silica glass doped with germanium increases the refractive index in the core because of the action of germanium present in the core. Therefore, projection of ultraviolet light interference patterns onto the optical fiber through the phase mask causes a cyclic change in refractive index in the core of the optical fiber, thereby forming a diffraction grating.

Conventionally, a grating is formed by causing a cyclic change in refractive index in the core of an optical waveguide such as, an optical fiber. Note that it is also possible to form a diffraction grating in an inner cladding of a two layer cladding (consisting of an inner cladding and an outer cladding) of the optical fiber or a like other optical waveguide by causing a similar change in refractive index of the inner cladding if the silica glass doped with germanium is also used for the inner cladding. Thus the optical fiber or a like other optical waveguide may have gratings both in the core and in the inner cladding as long as the inner cladding is also formed of silica glass doped with germanium. Other than the phase mask method, there is another method of forming a grating, called a holographic method that uses no masks.

When the above grating type optical component is adopted for system monitoring in the optical communication system of the wavelength division multiplexing light transmission method, the grating type optical component is obtained by forming, in an optical waveguide such as an optical fiber, a transmission light blocking range in a wavelength band that is different from the signal wavelength through the formation of the above grating. Signal light and monitoring light in the wavelength band of the transmission light blocking range are inputted from an input end of the grating type optical component. Then the signal light passes through the grating type optical component whereas the monitoring light is reflected by the component and goes toward the input end side of the grating type optical component. The signal light thus can be taken out of an output end of the grating type optical component while taking the monitoring light out of the input end of the grating type optical component.

A relatively small number of wavelengths, for example, eight wavelengths or sixteen wavelengths, are conventionally transmitted by the wavelength division multiplexing transmission in the optical communication system of the wavelength division multiplexing light transmission method. However, the speed and the capacity of the optical communication system is increasing in recent years, and now development of a new optical communication system is under way which can transfer light beams having as large a number of wavelengths as 160 by division multiplexing transmission. Accompanying with such movement, a demand has been born for a grating type optical component that has a multi-wavelength reflection filtering function to selectively reflect a plurality of light beams having, for example, four or twenty wavelengths out of light beams transmitted by the wavelength division multiplexing transmission, in addition to the function of taking out monitoring light as in the grating type optical component described above.

FIG. 5D shows an example of an optical module that has been proposed to meet such a demand. This optical module has a grating type optical component provided with the above multi-wavelength reflection filtering function. This optical module is an OADM (Optical ADD/DROP Multiplexer) module and sometimes called “add/drop module”.

Hereinafter a description will be given, with reference to FIGS. 5A to 5D, on a method of manufacturing the OADM module of the proposed example, the structure thereof, and the operation thereof. In the prior art, only one grating is formed in the grating type optical component and one grating forming pattern is drawn on a phase mask for forming the grating type optical component. If two or more gratings of different kinds are to be formed, firstly, a plurality of (four, in FIG. 5A) phase masks 8a, 8b, 8c, and 8d that respectively have grating forming patterns 1a, 1b, 1c, and 1d different from one another are prepared as shown in FIG. 5A.

Secondly, as shown in FIG. 5B, optical fibers 2a to 2d are respectively covered with their associated phase masks 8a to 8d. The optical fiber 2a is then irradiated with ultraviolet light (UV light) through the phase mask 8a. The optical fiber 2b is irradiated with ultraviolet light through the phase mask 8b. The optical fiber 2c is irradiated with ultraviolet light through the phase mask 8c. The optical fiber 2d is irradiated with ultraviolet light through the phase mask 8d.

After the optical fibers 2a to 2d are irradiated with ultraviolet light through the phase masks 8a to 8d, respectively, as described above, gratings 6a to 6d reflecting different wavelengths of light are formed in the optical fibers 2a to 2d, respectively. The gratings 6a to 6d are respectively housed in temperature compensating packages 3a to 3d for compensating the temperature dependency of the gratings. In FIGS. 5B to 5D, the grating 6a reflects light having a wavelength of λA, the grating 6b reflects light having a wavelength of λB, the grating 6c reflects light having a wavelength of λC, and the grating 6d reflects light having a wavelength of λD.

As shown in FIG. 5C, the optical fibers 2a to 2d are fusion spliced at fusion splicing portions 4 to be connected in series and form a single optical fiber 2. Thereafter, as shown in FIG. 5D, circulators 10a and 10b are connected to the optical fiber 2 so as to sandwich between them the serially-connected gratings 6a to 6d that are different in kind. The lined-up plural gratings 6a to 6d and the circulators 10a and 10b are then housed in a package 5.

An input port (In Port) 11 for inputting light is connected to an input terminal of the circulator 10a, and a drop port (Drop Port) 12 is connected to an output terminal of the circulator 10a. An add port (Add Port) 13 is connected to an input terminal of the circulator 10b, and an output port (Out Port) 14 is connected to an output terminal of the circulator 10b. The OADM module is thus completed upon connecting these ports.

Note that the process illustrated in FIGS. 5A and 5B may be replaced by another process in which only one phase mask 8a is used to form the plural kinds of gratings 6a to 6d as shown in FIG. 6. In that case, the optical fiber 2a is first irradiated with ultraviolet light through the phase mask 8a while applying a tensile force A to the optical fiber 2a, and then the optical fiber 2b is irradiated with ultraviolet light through the phase mask 8a while applying a tensile force B to the optical fiber 2b. The optical fibers 2c and 2d are similarly irradiated with ultraviolet light through the phase mask 8a while applying tensile forces C and D to the optical fibers 2c and 2d, respectively.

After that, the tensile forces A to D are removed to give the gratings 6a to 6d formed in the optical fibers 2a to 2d patterns that are different from one another. This makes the gratings 6a to 6d that are formed in the optical fibers 2a to 2d, respectively, reflect different wavelengths of light, as in the case where the manufacturing method illustrated in FIGS. 5A and 5B is used. The gratings 6a to 6d are housed in the temperature compensating packages 3a to 3d, respectively.

In this alternative process also, after the formation of the gratings, the optical fiber 2 is formed by fusion splicing and the gratings 6a to 6d are connected in series to form the OADM through a process similar to the one illustrated in FIGS. 5C and 5D.

Now, assume that multiplexed light beams having wavelengths of λA, λa, λB, λb, λC, λc, λD, and λd are inputted from the input port 11 of the OADM module that is formed by the above manufacturing method to have the structure described above, as shown in FIG. 5D. In this situation, the grating 6a reflects the inputted light beam having a wavelength of λA, the grating 6b reflects the inputted light beam having a wavelength of λB, the grating 6c reflects the inputted light beam having a wavelength of λC, and the grating 6d reflects the inputted light beam having a wavelength of λD. The reflection of these light beams having wavelengths of λA, λB, λC and λD thus can be taken out from the drop port 12.

On the other hand, the light beams having wavelengths of λa, λb, λc and λd pass thorough all of the gratings 6a, 6b, 6c and 6d and are outputted from the output port 14. If the light beams having wavelengths of λA, λB, λC and λD are inputted from the add port 13, these light beams enter the serially-connected gratings 6a to 6d formation side, and then reflected by the gratings 6a to 6d, respectively, to be outputted from the output port 14, similar to the above.

FIG. 7A shows, as an example of the proposed OADM module, the structure and the operation of an OADM module for four wavelengths in which the gratings 6a, 6b, 6c, and 6d reflect light beams having wavelengths of λ1, λ3, λ5 and λ7, respectively, to take them out. In this OADM module, if multiplexed light beams having, for instance, wavelengths of λ1, λ2, λ3, λ4, λ5, λ6, λ7 and λ8 are inputted from the light input port 11, the gratings 6a, 6b, 6c, and 6d reflect light beams having wavelengths of λB, λ3, λ5 and λ7, respectively, to take reflection of these light beams out from the drop port 12.

In the OADM module for four wavelengths, outputted from the output port 14 are the light beams having wavelengths of λ2, λ4, λ6 and λ8 that have passed through all the gratings 6a to 6d, as well as the light beams having wavelengths of λ1, λ3, λ5 and λ7 that have been inputted from the add port 13 and reflected by the gratings 6a, 6b, 6c, and 6d, respectively.

FIG. 7B shows, as another example of the proposed OADM module, the structure and the operation of an OADM module for eight wavelengths in which gratings 6a, 6b, . . . 6g, and 6h reflect light beams having wavelengths of λ1, λ3, . . . λ13 and λ15, respectively, to take reflection of these light beams out from the drop port 12.

In this OADM module for eight wavelengths, if multiplexed light beams having, for instance, wavelengths of λ1, λ2, λ3, λ4, λ5, λ6, . . . λ14, λ15, and λ16 are inputted from the input port 11, the gratings 6a, 6b, . . . 6g, and 6h reflect light beams having wavelengths of λ1, λ3, . . . λ13 and λ15, respectively, to take reflection of these light beams out from the drop port 12.

In the OADM module for eight wavelengths, outputted from the output port 14 are the light beams having wavelengths of λ2, λ4, . . . λ14 and λ16 that have passed through all the gratings 6a to 6h, as well as the light beams having wavelengths of λ1, λ3, λ13 and λ15 that have been inputted from the add port 13 and reflected by the gratings 6a to 6h, respectively.

Another proposed example of the grating type optical component is a cascade filter module (comb-like filter) as the ones shown in FIGS. 8A and 8B. Each of these cascade filter modules lacks the circulators 10a and 10b, the drop port 12, and the add port 13 of the above OADM module, and has an optical isolator 10c instead of the circulator 10a.

FIG. 8A shows a cascade filter module for five wavelengths, provided with gratings 6a, 6b, 6c, 6d, and 6e, which reflect light beams having wavelengths of λa, λb, λc, λd, and λe, respectively. In this cascade filter module for five wavelengths, multiplexed light beams having wavelengths of λa, λb, λc, λd, λe, λf, λg, . . . are inputted from the input port 11. These inputted light beams except for the ones to be reflected, namely, light beams having wavelengths of λf, λg, λh, . . . are selectively outputted from the light output port 14.

FIG. 8B shows a cascade filter module for sixteen wavelengths, provided with gratings 6a, 6b, . . . 6o, and 6p, which reflect light beams having wavelengths of λa, λb, . . . λo, and λp, respectively. In this cascade filter module for sixteen wavelengths, multiplexed light beams having wavelengths of λa, λb, λc, λd, . . . λp, λq, are inputted from the input port 11. These inputted light beams except for the ones to be reflected, namely, light beams having wavelengths of λq, λr, λs, . . . are selectively outputted from the light output port 14.

An optical fiber in which a grating is to be formed is often doped with a dopant such as fluorine. Having such composition, the optical fibers in which gratings are to be formed generate greater loss when fusion spliced than optical fibers that are generally used for optical transmission.

However, according to any of the manufacturing methods of the grating type optical components of the above proposed examples, the gratings 6a, 6b, . . . having different patterns are formed separately in different optical fibers 2a, 2b, . . . . The optical fibers 2a, 2b, . . . in which the gratings 6a, 6b, . . . are respectively formed are then fusion spliced at fusion splicing portions 4 and arranged in series. Therefore, each of the grating type optical components of the proposed example, formed by the above manufacturing methods, has a large number of fusion splicing portions 4, resulting in a problem of optical loss increased that much in total in the grating type optical component.

Moreover, a large number of fusion splicing portions 4 in the proposed grating type optical components and the proposed optical modules including the OADM modules bring about another problem of increasing cost in fusion splicing, which makes them costly grating type optical components and optical modules.

In addition, the temperature compensating packages 3a, 3b, . . . are very expensive. The proposed grating type optical components described above use those very expensive temperature compensating packages to house every grating separately. The cost for manufacturing the proposed grating type optical components and the proposed optical modules including the OADM modules is therefore very high.

The proposed OADM modules using the grating type optical component further has the following problem. For instance, in the OADM modules shown in FIGS. 7A and 7B, the light beam having a wavelength of λ1 is inputted from the input port 11, passes through the leftmost of the fusion splicing portions 4 in the drawings, is reflected by the grating 6a, and again passes through the leftmost of the fusion splicing portions 4 in the drawings to be taken out from the drop port 12. On the other hand, the light beam having a wavelength of λ3 passes through two of the fusion splicing portions 4, namely, the leftmost one and one on its right (the fusion splicing portion between the grating 6a and the grating 6b) in the drawings, is reflected by the grating 6b, and again passes through the above two of the fusion splicing portions 4 to be taken out from the drop port 12.

Thus, in the proposed OADM module, the number of fusion splicing portions 4 that the light beams having different wavelengths and reflected by different gratings pass in traveling back and forth between the input port 11 and the drop port 12 varies, depending on which light beam is being discussed (the travel back and forth actually means transmission of light from the input port it to one of the gratings 6a, 6b, . . . and transmission to the drop port 12 after the light is reflected by the one grating). The intensity of light taken out from the drop port 12 in the above OADM module therefore varies depending on the wavelengths of the light beams, which is very problematic.

### SUMMARY OF THE INVENTION

The present invention has been made to solve the above problems in prior art. A first object of the present invention is to provide a grating type optical component in which a plurality of light beams having different wavelengths can be reflected, the intensity of the reflection of the light beams is highly uniform, total loss in the optical component is small, and the cost is low, and to provide an optical module using this grating type optical component. A second object of the present invention is to provide a method of manufacturing a grating type optical component with which an excellent grating type optical component as above can readily be manufactured, and to provide a mask for use in this manufacturing method.

In order to attain the objects above, the present invention employs the following configurations as measures for solving the problems. According to a first aspect of the present invention, there is provided, as one of measures for solving the problems, a grating type optical component, in which plural kinds of gratings are together formed in a single optical waveguide having no connection portions.

A second aspect of the present invention takes, as one of measures for solving the problems, the grating type optical component of the first aspect of the invention, in which the plural kinds of gratings are together housed in a temperature compensating package for compensating the temperature dependency of the gratings.

In each of the grating type optical components of the first and second aspects of the present invention, plural kinds of gratings are together formed in a single optical waveguide having no connection portions. Therefore, unlike the above proposed example in which plural kinds of gratings are separately formed and then fusion spliced, respectively, there is no connection portion (fusion splicing portion) between any adjacent gratings of different kinds. It is therefore possible for the grating type optical component to reduce loss in total and to lower the manufacturing cost thereof.

The grating type optical component of the second aspect of the invention, in particular, uses one temperature compensating package to house the plural kinds of gratings together. The cost of the grating type optical component of the second aspect of the invention is thus considerably lower in comparison with the case where expensive temperature compensating packages are used to house every grating separately.

According to a third aspect of the present invention, there is provided, as one of measures for solving the problems, a grating type optical component, comprising:

a first grating part in which plural kinds of gratings are together formed in a single optical waveguide having no connection portions; and

one or more grating parts to be connected in series to the first grating part, in which

each of the grating parts to be connected to the first grating part is composed of one or more kinds of gratings that are together formed in a single optical waveguide having no connection portions.

A fourth aspect of the present invention takes, as one of measures for solving the problems, the grating type optical component of the third aspect of the invention, in which the one or more kinds of gratings formed in each of the plurality of grating parts are together housed in a temperature compensating package for compensating the temperature dependency of the gratings.

In each of the grating type optical components of the third and fourth aspects of the invention, the one or more grating parts are connected in series to the first grating part, the first grating part being composed of plural kinds of gratings that are together formed in a single optical waveguide having no connection portions, each of the grating parts being composed of one or more kinds of gratings that are together formed in a single optical waveguide having no connection portions. Therefore, the grating type optical components of the third and fourth aspects of the invention have considerably smaller number of connection portions in comparison with the above proposed example in which plural kinds of gratings are separately formed and then fusion spliced.

Thus the grating type optical components of the third and fourth aspects of the invention also can reduce loss in total and lower the manufacturing cost.

Moreover, the grating type optical component of the fourth aspect of the invention uses one temperature compensating package for each of the grating parts in order to house its gratings together. Therefore, as in the grating type optical component of the second aspect of the invention, the cost of the grating type optical component of the fourth aspect of the invention is considerably low.

A fifth aspect of the present invention takes, as one of measures for solving the problems, the grating type optical component of the first aspect of the invention, in which the optical waveguide is an optical fiber with its core surrounded by and covered with a cladding.

A sixth aspect of the present invention takes, as one of measures for solving the problems, the grating type optical component of the third aspect of the invention, in which the optical waveguide is an optical fiber with its core surrounded by and covered with a cladding.

In each of the grating type optical components of the fifth and sixth aspects of the present invention, the optical waveguide is comprised of an optical fiber, which facilitates application of the grating type optical component to optical communication or the like to a great degree. Using the grating type optical component of the fifth or sixth aspect of the present invention, an excellent optical module can be manufactured which functions as, for example, a filter reflecting plural different wavelengths of light and used in wavelength division multiplexing transmission.

According to a seventh aspect of the present invention, there is provided, as one of measures for solving the problems, a method of manufacturing a grating type optical component, comprising the steps of:

drawing on a mask a plurality of grating forming patterns different from one another;

covering an optical waveguide with the mask such that the grating forming patterns face the optical waveguide; and then irradiating the optical waveguide with ultraviolet light through the mask to form and arrange gratings in the optical waveguide at once.

The method of manufacturing a grating type optical component of the seventh aspect of the present invention has the configuration described above, so that the gratings are formed and arranged in the optical waveguide at once. Therefore, a plurality of gratings can be formed efficiently, a connection portion between the formed gratings is eliminated, and the distance between the gratings is made very short.

Thus it can be concluded that adoption of the method of manufacturing a grating type optical component of the seventh aspect of the present invention facilitates manufacturing those excellent grating type optical components of the present invention whose structure has been described in the above.

According to an eighth aspect of the present invention, there is provided, as one of measures for solving the problems, a mask for use in manufacturing a grating type optical component, in which a plurality of grating forming patterns different from one another are formed in a single mask.

In the mask of the eighth aspect of the present invention, which is for use in manufacturing, a grating type optical component, a plurality of grating forming patterns different from one another are formed in a single mask. The mask can therefore be used to form and arrange a plurality of gratings at once.

According to a ninth aspect of the present invention, there is provided, as one of measures for solving the problems, an optical module comprising a grating type optical component of the first aspect of the invention, in which:

circulators are connected to the respective ends of the grating type optical component so as to sandwich the component between the circulators;

a drop port is connected to the circulator on one side; and

an add port is connected to the circulator on the other side.

According to a tenth aspect of the present invention, there is provided, as one of measures for solving the problems, an optical module comprising a grating type optical component of the second aspect of the invention, in which:

circulators are connected to the respective ends of the grating type optical component so as to sandwich the component between the circulators;

a drop port is connected to the circulator on one side; and

an add port is connected to the circulator on the other side.

According to an eleventh aspect of the present invention, there is provided, as one of measures for solving the problems, an optical module comprising a grating type optical component of the third aspect of the invention, in which:

circulators are connected to the respective ends of the grating type optical component so as to sandwich the component between the circulators;

a drop port is connected to the circulator on one side; and

an add port is connected to the circulator on the other side.

According to a twelfth aspect of the present invention, there is provided, as one of measures for solving the problems, an optical module comprising a grating type optical component of the fourth aspect of the invention, in which:

circulators are connected to the respective ends of the grating type optical component so as to sandwich the component between the circulators;

a drop port is connected to the circulator on one side; and

an add port is connected to the circulator on the other side.

According to a thirteenth aspect of the present invention, there is provided, as one of measures for solving the problems, an optical module comprising a grating type optical component of the fifth aspect of the invention, in which:

circulators are connected to the respective ends of the grating type optical component so as to sandwich the component between the circulators;

a drop port is connected to the circulator on one side; and

an add port is connected to the circulator on the other side.

According to a fourteenth aspect of the present invention, there is provided, as one of measures for solving the problems, an optical module comprising a grating type optical component of the sixth aspect of the invention, in which:

circulators are connected to the respective ends of the grating type optical component so as to sandwich the component between the circulators;

a drop port is connected to the circulator on one side; and

an add port is connected to the circulator on the other side.

Each of the optical modules of the ninth to fourteenth aspects of the present invention can be used to form, for example, an OADM module in which plural kinds of gratings of a grating type optical component selectively reflect a plurality of light beams having different wavelengths out of light beams having undergone wavelength division multiplexing and take out the reflected light beams from a drop port. The optical modules of the ninth to fourteenth aspects of the present invention are excellent optical modules that possess the superior characteristic of the above grating type optical components of the present invention. They are also small-sized optical modules with reduced loss and cost.

The optical modules of the ninth to fourteenth aspects of the present invention do not have a connection portion between adjacent gratings of the grating type optical component, nor a connection portion between adjacent gratings of each of the plural grating parts that constitute the grating type optical component. Therefore, it is possible for the optical modules of the ninth to fourteenth aspects of the present invention to reduce the difference in intensity between a plurality of light beams that have different wavelengths and are taken out from the drop port.

According to a fifteenth aspect of the present invention, there is provided, as one of measures for solving the problems, an optical module comprising a grating type optical component of the first aspect of the invention, in which:

an isolator is connected to one end of the grating type optical component whereas an output port is connected to the other end thereof; and

an input port is connected to the isolator.

According to a sixteenth aspect of the present invention, there is provided, as one of measures for solving the problems, an optical module comprising a grating type optical component of the second aspect of the invention, in which:

an isolator is connected to one end of the grating type optical component whereas an output port is connected to the other end thereof; and

an input port is connected to the isolator.

According to a seventeenth aspect of the present invention, there is provided, as one of measures for solving the problems, an optical module comprising a grating type optical component of the third aspect of the invention, in which:

an isolator is connected to one end of the grating type optical component whereas an output port is connected to the other end thereof; and

an input port is connected to the isolator.

According to an eighteenth aspect of the present invention, there is provided, as one of measures for solving the problems, an optical module comprising a grating type optical component of the fourth aspect of the invention, in which:

an isolator is connected to one end of the grating type optical component whereas an output port is connected to the other end thereof; and

an input port is connected to the isolator.

According to a nineteenth aspect of the present invention, there is provided, as one of measures for solving the problems, an optical module comprising a grating type optical component of the fifth aspect of the invention, in which:

an isolator is connected to one end of the grating type optical component whereas an output port is connected to the other end thereof; and

an input port is connected to the isolator.

According to a twentieth aspect of the present invention, there is provided, as one of measures for solving the problems, an optical module comprising a grating type optical component of the sixth aspect of the invention, in which:

an isolator is connected to one end of the grating type optical component whereas an output port is connected to the other end thereof; and

an input port is connected to the isolator.

In each of the optical modules of the fifteenth to twentieth aspects of the present invention, for instance, the plural kinds of gratings of the grating type optical component can selectively reflect a plurality of light beams having different wavelengths out of light beams having undergone wavelength division multiplexing, while light beams that have passed through all kinds of the gratings are outputted from the output port. The optical modules of the fifteenth to twentieth aspects of the present invention are excellent optical modules that possess the superior characteristic of the above grating type optical components of the present invention. They are also small-sized optical modules with reduced loss and cost.

### BRIEF DESCRIPTION OF THE DRAWINGS

In the accompanying drawings:

FIG. 1 is an explanatory diagram showing a major part of a grating type optical component in accordance with Embodiment 1 of the present invention, with a schematic illustration of a method of manufacturing the component;

FIG. 2A shows an example of the structure of an optical module using the grating type optical component of Embodiment 1, whereas FIG. 2B is a schematic diagram showing an example of the structure of an optical module using a grating type optical component in accordance with Embodiment 2 of the present invention;

FIGS. 3A and 3B are schematic diagrams showing examples of the structure of optical modules using grating type optical components in accordance with Embodiment 3 and Embodiment 4 of the present invention, respectively;

FIGS. 4A to 4D are structural diagrams each showing a major part of a grating type optical component in accordance with other embodiments of the present invention;

FIGS. 5A to 5D are step-illustrating diagrams showing a proposed example of a method of manufacturing a conventional grating type optical component;

FIG. 6 is a step-illustrating diagram showing another proposed example of a method of manufacturing a conventional grating type optical component;

FIGS. 7A and 7B are schematic diagrams each showing an example of the structure of an OADM module manufactured by the conventional manufacturing method for the grating type optical component of the proposed example, and showing the operation thereof;

FIGS. 8A and 8B are schematic diagrams each showing an example of the structure of a cascade filter module manufactured by the conventional manufacturing method for the grating type optical component of the proposed example, and showing the operation thereof; and

FIG. 9 is an explanatory diagram showing an example of a device used to form a mask that has a plurality of grating forming patterns.

### DETAILED DESCRIPTION OF THE PREFERRED EMBODIMENT

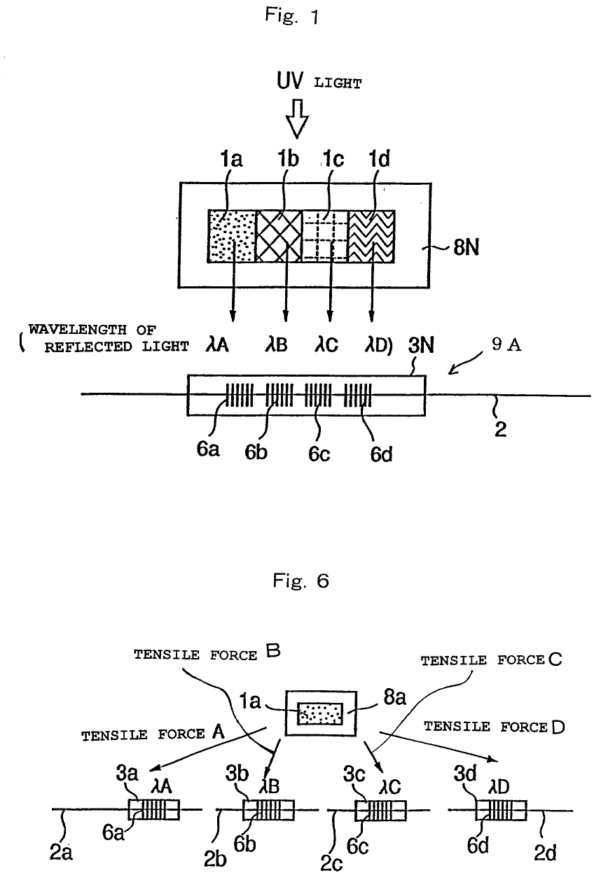

Embodiments of the present invention will be described below with reference to the drawings. The description in this embodiment uses the same reference symbols to denote the same parts as the conventional examples to avoid repeated explanation of the parts. FIG. 1 shows, in the form of a schematic diagram, a grating type optical component in accordance with Embodiment 1 of the present invention, with a schematic illustration of a method of manufacturing the component.

As shown in FIG. 1, a grating type optical component 9A of this embodiment is composed of plural (four, in the drawing) kinds of gratings 6a to 6d together formed in an optical fiber 2 that is a single optical waveguide having no connection portions. In the grating type optical component 9A of this embodiment, the gratings 6a to 6d are together housed in a temperature compensating package 3N.

The gratings 6a, 6b, 6c, and 6d reflects light beams having wavelengths of λA, λB, λC, and λD, respectively.

Given next is a description of a method of manufacturing the grating type optical component 9A of this embodiment, which is structured as above. This embodiment also employs the phase mask method in manufacturing the grating type optical component 9A. Note that the mask used in the phase mask method in this embodiment is a characteristic phase mask 8N shown in FIG. 1. This phase mask 8N is a single mask in which a plurality of (four, in the drawing) grating forming patterns 1a to 1d different from one another are formed and transversely lined up.

In this embodiment, the phase mask 8N covers the optical fiber 2 such that the grating forming patterns 1a to 1d face the optical fiber 2. Then the optical fiber 2 is irradiated with ultraviolet light through the phase mask 8N in this embodiment to thereby form the plural kinds of gratings 6a to 6d at once and arrange them serially in the longitudinal direction of the optical fiber 2. The gratings 6a to 6d reflect different wavelengths of light.

In this embodiment, the length of each of the gratings 6a to 6d formed in the optical fiber 2 is set to about 6 to 7 mm, and the distance between adjacent gratings is almost nil. Accordingly, the length of the lined-up gratings, i.e., from the left end of the grating 6a to the right end of the grating 6d is less than 30 mm in the grating type optical component 9A of this embodiment. The grating type optical component 9A can have the four kinds of gratings 6a to 6d formed and arranged at once by using, as a light source for the ultraviolet irradiation, an excimer laser whose oscillating portion has a length of about 30 mm.

If the length from the left end of the grating 6a to the right end of the grating 6d is equal to or larger than 30 mm, the four kinds of gratings 6a to 6d still can be formed and arranged at once if laser light scanning is used.

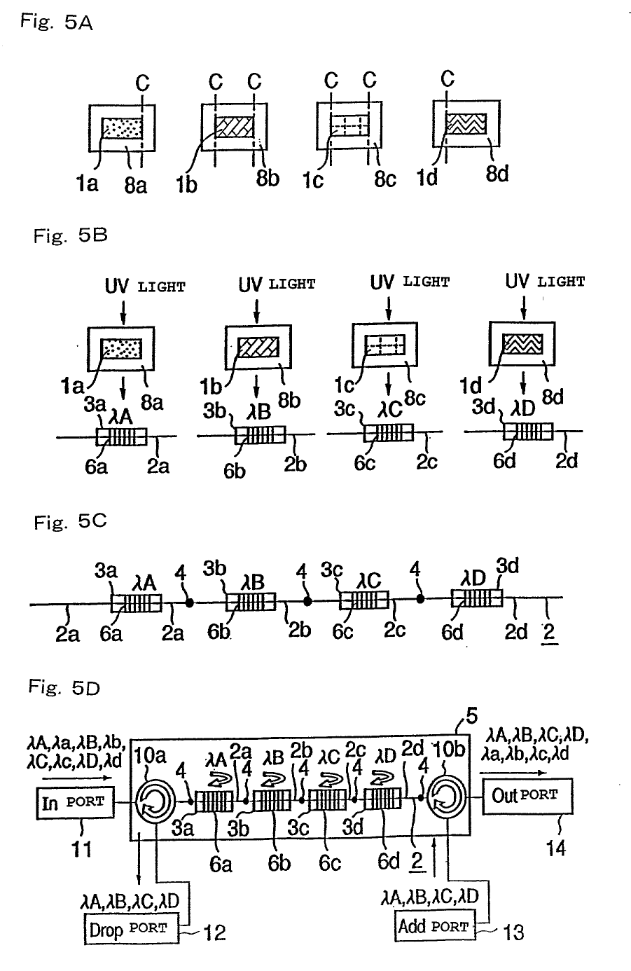

The phase mask 8N used to manufacture the grating type optical component 9A of this embodiment is formed as follows. For instance, phase masks 8a to 8d are cut along the perforated lines indicated by the broken lines C in FIG. 5A to be separated from one another, and then the grating forming patterns 1a to 1d are serially arranged while holding the masks with an appropriate phase mask holding member. The gap between the phase masks is covered with a substrate such as a ultraviolet light shielding film or with some oil.

The following method may also be adopted to form a plurality of grating forming patterns 1a to 1d different from another in the single phase mask 8N. According to this alternative method, first, interference patterns corresponding to the plural grating forming patterns different from one another are formed in a photo resist by applying a known holographic method, and a silica plate integrated with the photo resist is etched. Thereafter, an organic solvent (acetone, for example) or oxygen plasma is used to remove the photo resist, making the surface of the silica plate uneven for the grating forming patterns 1a to 1d different from one another.

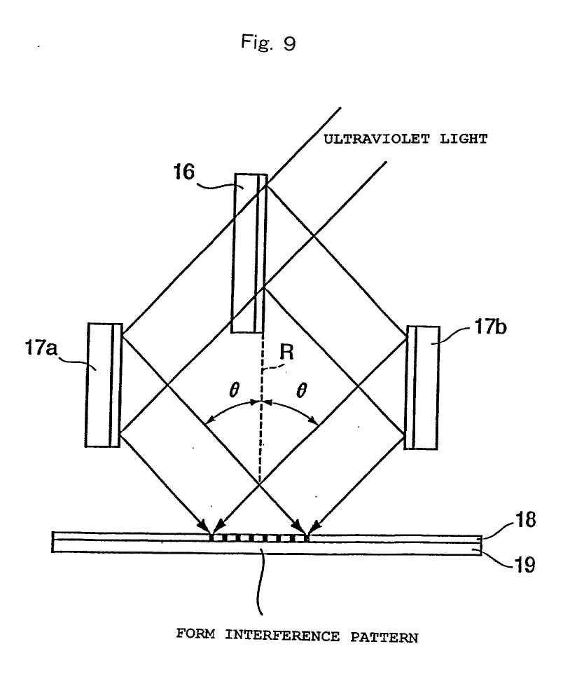

For instance, a beam splitter 16 is fixedly arranged so that the splitter is perpendicular to the surface of a photo resist 18, as shown in FIG. 9. Then mirrors 17a and 17b, for instance, are placed such that they are symmetrical with respect to a vertical line R (an extended line of the beam splitter 16 toward the photo resist 18) shown in the drawing, and reflection surfaces of the mirrors 17a and 17b are perpendicular to the surface of the photo resist 18.

The beam splitter 16 splits the ultraviolet light and the split beams enter the reflection surfaces of the mirrors 17a and 17b, respectively. Both the light beams reflected by these mirrors 17a and 17b enter the photo resist 18 to induce interference patterns of an appropriate cycle in the photo resist 18 by the interference of the light beams reflected by the two mirrors 17a and 17b. The cycle of this interference patterns can be changed by changing an angle of incidence θ at which the light beams reflected by the mirrors 17a and 17b enter the photo resist 18 and by changing the distance between the mirrors 17a and 17b.

It is thus possible to form different kinds of interference patterns in the photo resist 18. After one kind of interference patterns are formed, the photo resist 18 is moved to, for example, the left to form a different kind of interference patterns on the right of the previously formed interference patterns, by changing the angle of incidence θ or the distance between the mirrors 17a and 17b. Repeating this operation of forming different kind of interference patterns, it is possible to form, in the photo resist 18, interference patterns with several (four, for example) kinds of cycles arranged transversely.

As mentioned above, if the mirrors 17a and 17b are to be moved, they have to be symmetrical with respect to the vertical line R after the moving. Also, the photo resist 18 should be moved remaining perpendicular to the previously formed interference patterns.

Using the photo resist 18 in which the interference patterns having four kinds of cycles are formed, a silica plate 19 integrated with the photo resist 18 is etched. The photo resist 18 is then removed to form unevenness corresponding to the interference patterns. In this way, the phase mask 8N with the transversely-arranged grating forming patterns 1a to 1d different from one another can be formed as shown in FIG. 1.

The grating type optical component 9A of this embodiment is manufactured by using the phase mask 8N, in which the plural grating forming patterns different from one another are formed and arranged transversely, to form at once the plural kinds of gratings 6a to 6d that reflect different wavelengths of light in the optical fiber 2 and arrange the gratings serially in the longitudinal direction of the optical fiber 2, as described above. Thus there is no connection portions formed between adjacent gratings (6a and 6b, 6b and 6c, and 6c and 6d in FIG. 1) in the grating type optical component 9A of this embodiment, making loss in the grating type optical component 9A small in total.

The grating type optical component 9A of this embodiment, which eliminates any connection portion between adjacent gratings, can be manufactured with a cost reduced that much. In addition, the intensity of reflected light beams having different wavelengths can be almost unified in the grating type optical component 9A.

Moreover, the distance between any two gratings of the gratings 6a to 6d is very short, and the plural kinds of gratings 6a to 6d connected in series are together housed in one temperature compensating package 3N, in the grating type optical component 9A of this embodiment. Therefore, the cost of the grating type optical component 9A of this embodiment is considerably lower in comparison with the proposed example in which expensive temperature compensating packages are used to house every grating separately. This also contributes to down-sizing of the grating type optical component 9A.

The grating type optical component 9A of this embodiment is manufactured by adopting the above manufacturing method to form and arrange the plural kinds of gratings 6a to 6d at once. Therefore, manufacturing of this grating type optical component, in which the plural kinds of gratings 6a to 6d are arranged serially in the longitudinal direction of the optical fiber 2, is very efficient.

If an optical module is formed using the grating type optical component 9A of this embodiment, loss in the optical module can be reduced in total and both the manufacturing cost and the parts cost can be lowered. Furthermore, the optical module composed of the grating type optical component 9A of this embodiment can be reduced in size and can uniform the intensity of light beams that have different wavelengths and are reflected by the respective gratings 6a to 6d to be taken out.

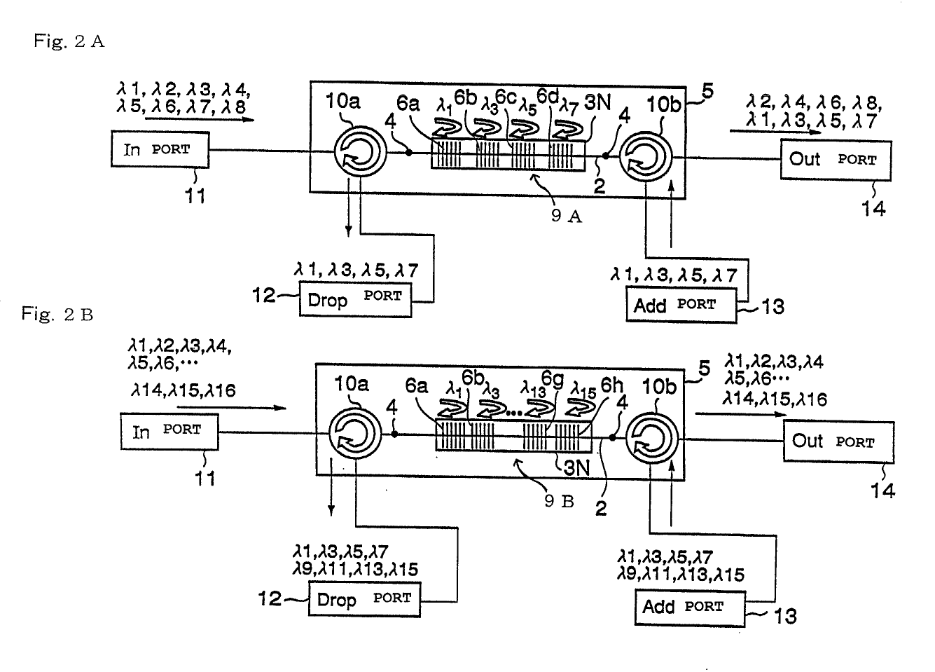

FIG. 2A shows an example of an optical module using the grating type optical component 9A of the above embodiment. In this optical module, circulators 10a and 10b are connected to the respective ends of the of the grating type optical component 9A so as to sandwich the plural kinds of lined-up gratings 6a to 6d thereof, and a package 5 houses the grating type optical component 9A together with the circulators 10a and 10b.

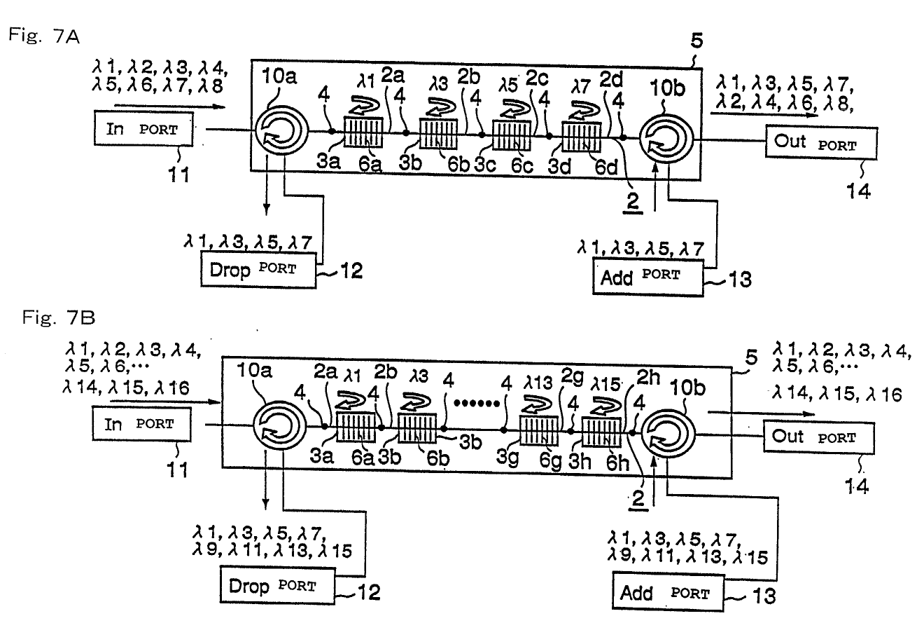

The circulator 10a on one side is connected to a drop port 12 whereas the circulator 10b on the other side is connected to an add port 13, in this optical module. This is an OADM module for four wavelengths which has a function equivalent to that of the OADM module of the proposed example illustrated in FIG. 7A.

FIG. 2B shows a grating type optical component in accordance with Embodiment 2 of the present invention, with the component being incorporated in an optical module. A grating type optical component 9B of Embodiment 2 is composed of eight kinds of gratings 6a to 6h that are together formed in an optical fiber 2. These gratings 6a to 6h are together housed in a temperature compensating package 3N in the grating type optical component 9B.

The rest of the structure of the grating type optical component 9B in accordance with Embodiment 2, and the manufacturing method thereof, are the same as Embodiment 1. Therefore, the explanation thereof will be omitted.

In the optical module shown in FIG. 2B, circulators 10a and 10b are connected to the respective ends of the grating type optical component 9B so as to sandwich the plural kinds of lined-up gratings 6a to 6h thereof, and a package 5 houses the grating type optical component 9B together with the circulators 10a and 10b.

The circulator 10a on one side is connected to a drop port 12 whereas the circulator 10b on the other side is connected to an add port 13, in this optical module. This is an OADM module for eight wavelengths which has a function equivalent to that of the OADM module of the proposed example illustrated in FIG. 7B.

In the optical modules shown in FIGS. 2A and 2B, no particular limitation is put on the length and the interval of the patterns (cycles and the like) of the gratings 6a, 6b, . . . , and neither the wavelengths of the light beams to be reflected by the gratings 6a, 6b, . . . . These parameters are set to suit one's purpose.

The grating type optical components 9A and 9B in accordance with Embodiments 1 and 2 have no fusion splicing portions 4 between adjacent gratings (6a and 6b, 6b and 6c, 6c and 6d, . . . in FIGS. 2A and 2B). This means that there are only two fusion splicing portions 4 in the optical fiber 2 of each of the OADM modules shown in FIGS. 2A and 2B; one is between the circulator 10a and the plural kinds of serially-connected gratings 6a, 6b, . . . , and the other is between the circulator 10b and the plural kinds of serially-connected gratings 6a, 6b, . . . .

Thus each of the optical modules shown in FIGS. 2A and 2B has far less fusion splicing portions 4 as compared to the grating type optical components of the proposed examples shown in FIGS. 7A and 7B. This makes the connection loss due to the fusion splicing portions 4 considerably smaller in total compared with the OADM modules of the proposed examples.

Now, consider the connection loss between the input port and the drop port in an OADM module for four wavelengths, in regard to a light beam having a wavelength of λ7, when each of the fusion splicing portions 4 causes a connection loss of 0.15 dB (the input port-drop port connection loss is specifically a connection loss caused by the fusion splicing portions 4 during the light inputted from the input port 11 travels the path to be outputted from the drop port 12). Calculating the connection loss, it is 1.2 dB in the structure shown in FIG. 7A, for the light beam having a wavelength of λ7 passes through four fusion splicing portions 4 and again passes the four of them on its way back (eight times in total). The connection loss is 0.3 dB in the structure of Embodiment 1 shown in FIG. 2A, for the light beam having a wavelength of λ7 passes through only one of the fusion splicing portions 4 and again on its way back (twice in total).

In short, the grating type optical component 9A of Embodiment 1 can reduce the input port-drop port connection loss in the OADM module for four wavelengths by 0.9 dB as compared with the proposed example.

Exact a similar calculation on, this time, light beam having a wavelength of λ15 to obtain the connection loss between the input port and the drop port in an OADM module for eight wavelengths when each of the fusion splicing portions 4 causes a connection loss of 0.15 dB. The connection loss in the structure of the proposed example shown in FIG. 7B is 2.4 dB whereas the connection loss in the structure shown in FIG. 2B is 0.3 dB. The grating type optical component 9B of Embodiment 2 can reduce the input port-drop port connection loss in the OADM module for eight wavelengths by 2.1 dB as compared with the proposed example.

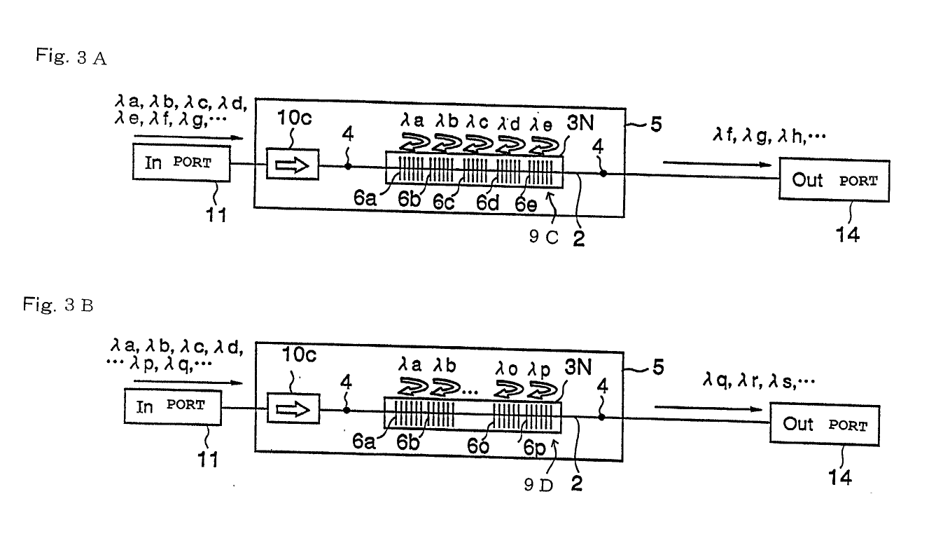

FIGS. 3A and 3B show grating type optical components of Embodiment 3 and Embodiment 4 of the present invention, respectively, with the components being incorporated in optical modules.

A grating type optical component 9C of Embodiment 3 is composed of five kinds of gratings 6a to 6e together formed in an optical fiber 2. In the grating type optical component 9C, these gratings 6a to 6e are together housed in a temperature compensating package 3N.

A grating type optical component 9D of Embodiment 4 is composed of sixteen kinds of gratings 6a to 6p together formed in an optical fiber 2. In the grating type optical component 9D, these gratings 6a to 6p are together housed in a temperature compensating package 3N.

No particular limitation is put on the length and the interval of the patterns (cycles and the like) of the gratings 6a, 6b, , formed in these modules and neither the wavelengths of the light beams to be reflected by the gratings 6a, 6b, . . . . These parameters are set to suit one's purpose. The rest of the structure of the grating type optical components 9C and 9D in accordance with Embodiments 3 and 4, and the manufacturing methods thereof, are the same as Embodiment 1. Therefore, the explanation thereof will be omitted.

In the optical module shown in FIG. 3A, an isolator 10c is connected to one end of the grating type optical component 9C of Embodiment 3, i.e., one end of the plural kinds of lined-up gratings 6a to 6e, whereas an output port 14 is connected to the other end thereof. In this optical module, the grating type optical component 9C and the isolator 10c are housed in a package 5, and an input port 11 is connected to the isolator 10c.

In the optical module shown in FIG. 3B, an isolator 10c is connected to one end of the grating type optical component 9D of Embodiment 4, i.e., one end of the plural kinds of lined-up gratings 6a to 6p, whereas an output port 14 is connected to the other end thereof. In this optical module, the grating type optical component 9D and the isolator 10c are housed in a package 5, and an input port 11 is connected to the isolator 10c.

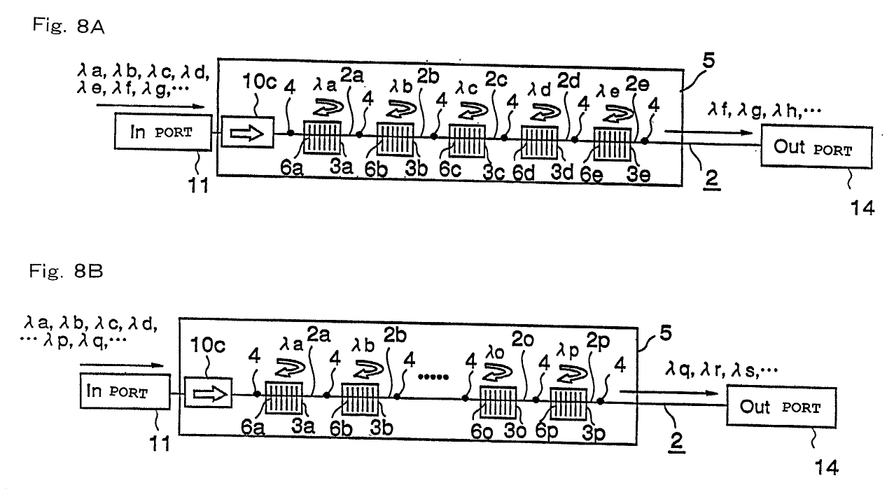

The optical modules shown in FIGS. 3A and 3B are a cascade filter module for five wavelengths and a cascade filter module for sixteen wavelengths, respectively, and have the same functions as those of the cascade filter modules of the proposed examples shown in FIGS. 8A and 8B.

The grating type optical components 9C and 9D have no fusion splicing portions 4 between adjacent gratings. This means that, in the case of these cascade filter modules of FIGS. 3A and 3B also, there are only two fusion splicing portions 4 in the optical fiber 2. Thus each of the cascade filter modules has far less fusion splicing portions 4 as compared to the grating type optical components of the proposed examples, resulting in a remarkable improvement in regard to the connection loss between the input port 11 and the output port 14.

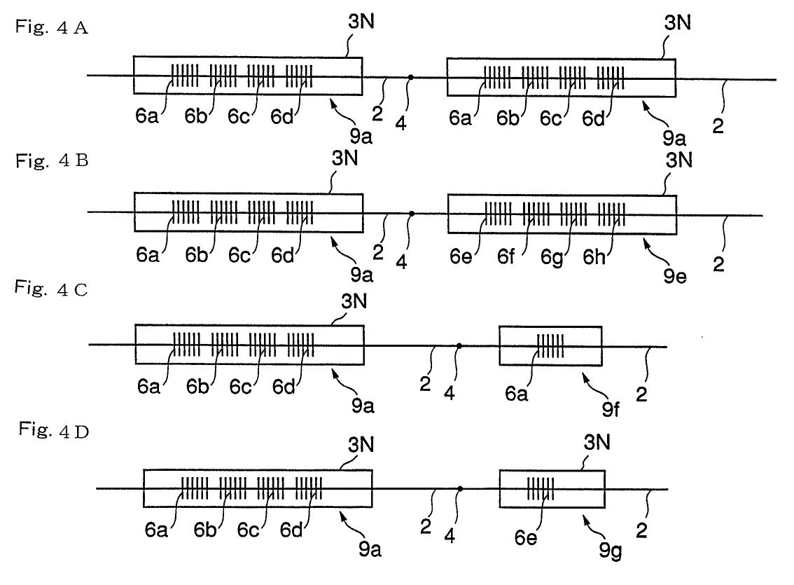

Note that the present invention is not limited to the above embodiments, but may take various modes in carrying out the invention. For instance, the grating type optical component, which is structured in the above embodiments as the grating type optical components 9A to 9D such that plural kinds of gratings 6a, 6b, . . . are together formed in a single optical fiber 2 having no connection portions, may take a structure as the ones shown in FIGS. 4A to 4D.

According to the structures shown in FIGS. 4A to 4D, a first grating part 9a is connected in series to one or more grating parts (for example, 9a, 9e, 9f, 9g). The first grating part 9a is composed of plural kinds of gratings 6a to 6d together formed in a single optical fiber 2 that has no connection portions. Each of the grating parts to be connected to the first grating part 9a is composed of one or more kinds of gratings together formed in a single optical fiber 2 that has no connection portions. Here, only one grating part is connected to the first grating part 9a.

Each of the grating type optical components shown in FIGS. 4A to 4D has only one grating part connected in series to the first grating part 9a. However, the first grating part 9a may be connected in series to a plurality of grating parts. Also, the structure of the first grating part 9a is not limited to the one shown in FIGS. 4A to 4D, and the kinds and the number of the gratings are determined to suit one's purpose.

The grating type optical component shown in FIG. 4A has two of the first grating part 9a, which are connected to each other.

The grating type optical component shown in FIG. 4B has the first grating part 9a and a grating part 9e connected thereto. The first grating part 9a has four kinds of gratings 6a to 6d. The grating part 9e has plural kinds of gratings 6e to 6h that are different from the gratings 6a to 6d of the first grating part 9a and are together formed in an optical fiber 2.

The grating type optical component shown in FIG. 4C has the first grating part 9a and a grating part 9f connected thereto. The first grating part 9a has four kinds of gratings 6a to 6d. The grating part 9f has one of the gratings 6a to 6d of the first grating part 9a, here, the grating 6a, and the grating 6a is formed in an optical fiber 2. The grating part 9f may have the grating 6b, the grating 6c, or the grating 6d, instead.

The grating type optical component shown in FIG. 4D has the first grating part 9a and a grating part 9g connected thereto. The first grating part 9a has four kinds of gratings 6a to 6d. The grating part 9g has a grating 6e that is different from the gratings 6a to 6d of the first grating part 9a and is formed in an optical fiber 2.

The grating type optical components shown in FIGS. 4A to 4D use one temperature compensating package 3N for each of the grating parts in order to together house one or more gratings 6a, 6b, that are formed in the respective grating parts 9a and 9e to 9g. The temperature compensating package 3N is for compensating the temperature dependency of the gratings.

As in the above embodiments, the grating type optical component thus structured has far less fusion splicing portions 4 as compared to the proposed examples in which plural kinds of gratings are separately formed and then fusion spliced to one another. Therefore, in the case of the grating type optical components shown in FIGS. 4A to 4D also, the connection loss in each grating type optical component is small in total and manufacturing cost thereof is low.

A phase mask 8N adopted when a mask is to be used to form a grating type optical component as in the above embodiments is not particularly limited in kinds and number of its grating forming patterns, nor the arrangement of the patterns. These are properly set to meet one's purpose.

For instance, arrangement of the plural grating forming patterns to be formed in the phase mask 8N is not particularly limited but suitably set although the phase mask 8N used in the above embodiments has a plurality of grating forming patterns different from one another which are arranged serially. The phase mask 8N may have a plurality of grating forming patterns that arranged, say, somewhat obliquely.

Also, no particular limitation is put on the method of forming the phase mask 8N and any suitable method can be employed. The phase mask 8N may be formed by the method described above: a plurality of phase masks are prepared which are different from one another in regard to the grating forming patterns. The grating forming patterns in each of the phase masks are arranged serially by an appropriate phase mask holding member. The gap between the phase masks is covered with a substrate such as a ultraviolet light shielding film or with some oil.

In another method of forming the phase mask 8N, a plurality of grating forming patterns different from one another are sequentially written in a single phase mask by moving either the position of a light source or the position of the phase mask every time a new pattern is to be formed.

In still another method of forming the phase mask 8N, as mentioned in the above, the holographic method is applied. Using the device shown in FIG. 9, for example, the above-described operation of forming different kinds of interference patterns is repeated to form and arrange serially in a photo resist 18 plural kinds of interference patterns that correspond to the plural grating forming patterns and are different from one another in terms of cycle. Then a silica plate 19 integrated with the photo resist 18 is etched. An organic solvent (acetone, for example) or oxygen plasma is used to remove the photo resist, making the surface of the silica plate uneven so as to correspond to the grating forming patterns. This method also is capable of forming the phase mask 8N in which plural kinds of grating forming patterns different from one another are formed.

An OADM module and a cascade filter module are taken as examples of optical modules using the grating type optical components of the above embodiments. However, the optical module using the grating type optical component of the present invention is not limited to an OADM module or a cascade filter module.

To elaborate, any optical module having a grating type optical component that is composed of plural kinds of gratings together formed in a single waveguide having no connection portions can constitute the optical module of the present invention. Any optical module having a grating type optical component that is composed of a first grating part connected in series to one or more grating parts, the first grating part having plural kinds of gratings together formed in a single optical waveguide with no connection portions, each of the one or more grating parts having one or more kinds of gratings together formed in a single optical waveguide with no connection portions, can also constitute the optical module of the present invention.

The gratings are together formed in the optical fiber 2 as an optical waveguide in the grating type optical component of the present invention. However, the gratings may be together formed in an optical waveguide other than the optical fiber 2.

What is claimed is:

1. A grating type optical component, wherein plural kinds of gratings are together formed in a single optical waveguide having no connection portions.

2. A grating type optical component according to claim 1, wherein said plural kinds of gratings are together housed in a temperature compensating package for compensating the temperature dependency of said gratings.

3. A grating type optical component, comprising:
a first grating part in which plural kinds of gratings are together formed in a single optical waveguide having no connection portions; and
one or more grating parts to be connected in series to said first grating part, wherein
each of said grating parts to be connected to said first grating part is composed of one or more kinds of gratings that are together formed in a single optical waveguide having no connection portions.

4. A grating type optical component according to claim 3, wherein said one or more kinds of gratings formed in each of said plurality of grating parts are together housed in a temperature compensating package for compensating the temperature dependency of said gratings.

5. A grating type optical component according to claim 1, wherein said optical waveguide is an optical fiber with its core surrounded by and covered with a cladding.

6. A grating type optical component according to claim 3, wherein said optical waveguide is an optical fiber with its core surrounded by and covered with a cladding.

7. A method of manufacturing a grating type optical component, comprising the steps of:
drawing on a mask a plurality of grating forming patterns different from one another;
covering an optical waveguide with said mask such that the respective grating forming patterns face said optical waveguide; and then
irradiating said optical waveguide with ultraviolet light through said mask to form and arrange gratings in said optical waveguide at once.

8. A mask for use in manufacturing a grating type optical component, wherein a plurality of grating forming patterns different from one another are formed in a single mask.

9. An optical module comprising a grating type optical component according to claim 1, wherein:
circulators are connected to the respective ends of said grating type optical component so as to sandwich the component between the circulators;
a drop port is connected to said circulator on one side; and
an add port is connected to said circulator on the other side.

10. An optical module comprising a grating type optical component according to claim 2, wherein:
circulators are connected to the respective ends of said grating type optical component so as to sandwich the component between the circulators;
a drop port is connected to said circulator on one side; and
an add port is connected to said circulator on the other side.

11. An optical module comprising a grating type optical component according to claim 3, wherein:
circulators are connected to the respective ends of said grating type optical component so as to sandwich the component between the circulators;
a drop port is connected to said circulator on one side; and
an add port is connected to said circulator on the other side.

12. An optical module comprising a grating type optical component according to claim 4, wherein:
circulators are connected to the respective ends of said grating type optical component so as to sandwich the component between the circulators;
a drop port is connected to said circulator on one side; and
an add port is connected to said circulator on the other side.

13. An optical module comprising a grating type optical component according to claim 5, wherein:
circulators are connected to the respective ends of said grating type optical component so as to sandwich the component between the circulators;
a drop port is connected to said circulator on one side; and
an add port is connected to said circulator on the other side.

14. An optical module comprising a grating type optical component according to claim 6, wherein:
circulators are connected to the respective ends of said grating type optical component so as to sandwich the component between the circulators;
a drop port is connected to said circulator on one side; and
an add port is connected to said circulator on the other side.

15. An optical module comprising a grating type optical component according to claim 1, wherein:
an isolator is connected to one end of said grating type optical component whereas an output port is connected to the other end thereof; and
an input port is connected to said isolator.

16. An optical module comprising a grating type optical component according to claim 1, wherein:
an isolator is connected to one end of said grating type optical component whereas an output port is connected to the other end thereof; and
an input port is connected to said isolator.

17. An optical module comprising a grating type optical component according to claim 1, wherein:
an isolator is connected to one end of said grating type optical component whereas an output port is connected to the other end thereof; and
an input port is connected to said isolator.

18. An optical module comprising a grating type optical component according to claim 1, wherein:
an isolator is connected to one end of said grating type optical component whereas an output port is connected to the other end thereof; and
an input port is connected to said isolator.

19. An optical module comprising a grating type optical component according to claim 1, wherein:
an isolator is connected to one end of said grating type optical component whereas an output port is connected to the other end thereof; and
an input port is connected to said isolator.

20. An optical module comprising a grating type optical component according to claim 1, wherein:
an isolator is connected to one end of said grating type optical component whereas an output port is connected to the other end thereof; and
an input port is connected to said isolator.
